(19) United States
(12) Patent Application Publication
(10) Pub. No.: US 2007/0239853 A1
(43) Pub. Date: Oct. 11, 2007

(54) Fault prediction agent design for a multi core system

(76) Inventors: Rajeev Tiwari, Bangalore (IN); Mansoor Ahamed Basheer Ahamed, Bangalore (IN); Padmashree K. Apparao, Portland, OR (US)

Correspondence Address: BUCKLEY, MASCHOFF & TALWALKAR LLC, 50 LOCUST AVENUE, NEW CANAAN, CT, 06840, US

(21) Appl. No.: 11/394,857

(22) Filed: Mar. 30, 2006

(51) Int. Cl. G06F 15/16

(52) U.S. Cl. 709/218

(57) ABSTRACT

According to some embodiments, a virtual network driver is provided to support multicored chipsets.

### BACKGROUND

A fault predictor analyzes error data and applies heuristic algorithms to predict the reliability of electronic component systems based on their error history and correlation of individual component errors with other conditions or factors related to a platform. In some embodiments, a multicore processor can be a single chipset with more than one processing unit or multiple chipsets each operating as a single processing unit. The invdividual processing units may be referred to as cores. A multicored processor may comprise for example, a main partition or core and at least one sequestered partition or core. The advantage to a multicored processor over a single cored processor may be that each core can execute multiple instructions. Typically, in a multicored environment, it can be difficult to migrate error data from one core to another for collection purposes.

### BRIEF DESCRIPTION OF THE DRAWINGS

FIG. 1 is a block diagram of a method according to some embodiments.

FIG. 2 is a block diagram of a method according to some embodiments.

FIG. 3 is a block diagram of a method according to some embodiments.

FIG. 4 is a functional block diagram of a system according to some embodiments.

FIG. 5 is a functional block diagram of a system according to some embodiments.

FIG. 6 is a functional block diagram of a system according to some embodiments.

### DETAILED DESCRIPTION

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

Some embodiments described herein are associated with data or information “network packets.” As used herein, the term “network packet” may refer to any set of data or information, such as a set of data associated with a communication protocol. By way of example, an information packet might be associated with the Fast Ethernet Local Area Network (LAN) transmission standard 802.3-2002® published by the Institute of Electrical and Electronics Engineers (IEEE).

Moreover, some embodiments are associated with “memory sensors” or “memory registers.” As used herein these terms may refer to any device or component adapted to store information. For example, a memory sensor or memory register may be a fixed-sized area of a device or module that is used to store and retrieve information packets.

In a multicored environment it may be difficult to migrate error from one core to another. A fault prediction agent that provides a single virtual network device interface to user applications, such as a knowledge engine, may provided the flexibility of being able to plug in other types of inter-core communication mechanism that might be available. One such mechanism that may be used to gather information from one or more sequestered partitions and sent to a main partition is an inter-process interrupt mechanism.

A fault prediction agent (“FPA”) in some embodiments is a piece of software or firmware running on a system that responds to requests made by a fault predictor or a knowledge engine. The fault prediction agent may be used to collect required data needed for the fault predictor, for example, the fault prediction agent may gather statistical information about errors generated in a multicored environment. However, the fault prediction agent or a similar agent may also be used to gather various autonomous capabilities of the component system such as power management or processor management. Gathering data via a fault prediction agent may make systems more reliable, available, and serviceable.

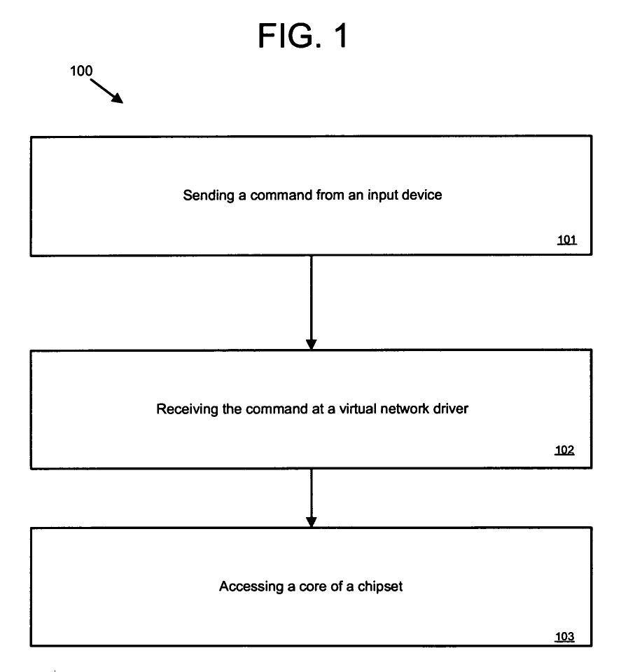

Referring now to FIG. 1, an embodiment of a method 100 is shown. At 101 an input device sends a command. In some embodiments, the input device may be a knowledge engine. A knowledge engine may contain heuristic algorithms or other policy-making rules that aid in decision-making processes. One embodiment of a knowledge engine is a C Language Integrated Production System (“CLIPS”). At 102 a virtual network driver receives the command from the input device. The virtual network driver may be a chipset specific driver in which register locations of one or more chipset are known. At 103 the virtual network driver accesses the chipset core based on the command sent from the input device. The chipset accessed at 103 in some embodiments may contain either a single core, be multicored, or may consist of multiple chipsets. In some embodiments the chipset accessed in 103 may contain any of one or more model specific registers (“MSR”), one or more debug registers, and one or more debug sensors. Such registers may contain data used by the knowledge engine.

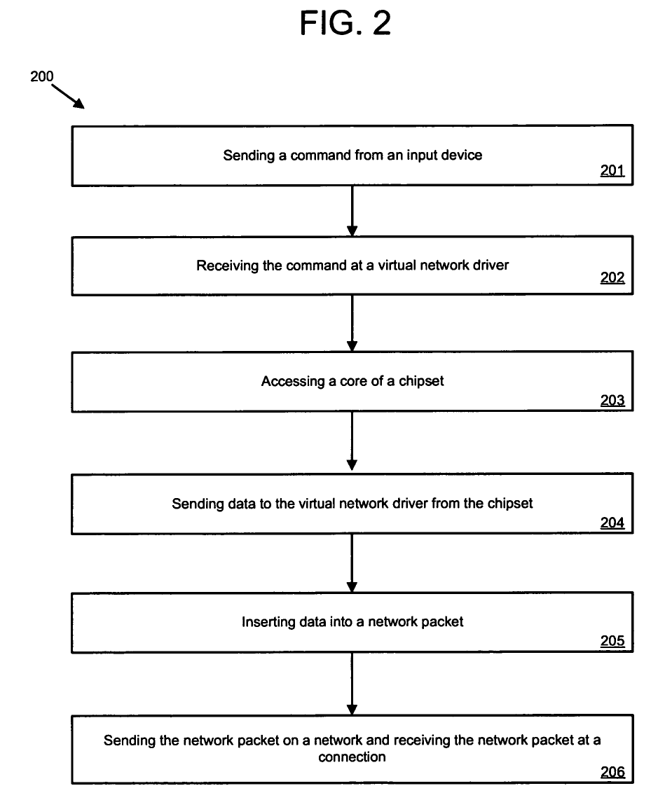

Referring now to FIG. 2, an embodiment of a method 200 is shown. At 201, an input device sends a command. In some embodiments, the input device may be a knowledge engine as described previously. At 202 a virtual network driver receives the command from the input device. The virtual network driver may be a chipset specific driver in which register locations of one or more chipsets are known. At 203 the virtual network driver accesses a chipset core based on the command sent from the input device. In some embodiments the virtual network driver will contain information on multiple chipsets and, in this example, one specific chipset code will be used to access a first core on a first chipset and a second chipset code will be used to access a second core on a second chipset. The chipset core or cores accessed at 203 in some embodiments may contain either a single core, be multicored, or may consist of multiple chipsets. In some embodiments the chipset accessed in 203 may contain any of one or more MSRs, one or more debug registers, and one or more debug sensors. Such registers may contain data used by a knowledge engine. In some embodiments, the input device may be a knowledge engine.

At 204 the chipset core sends data to the virtual network driver and the virtual network driver receives the data. The data sent may be the data requested by the command initially sent to the virtual network driver at 202.

At 205 a network subsystem creates a network packet that contains the requested data. In some embodiments, the network packet is an IEEE 802.3 or an Ethernet packet, and the network subsystem creates a network packet by adding IEEE 802.3 or Ethernet header information, Internet protocol header information and inserting the error data into the packet. In some embodiments, the virtual network driver creates the network packet. The network packet may be inserted into a socket buffer list that may be maintained by an operating system.

At 206 the network packet may be handed over to the socket buffer list and may be sent via a network and received at a connection. In some embodiments, the connection can be a User Datagram Protocol (“UDP”) socket as defined by the Internet Engineering Task Force (IETF) standard 6, Request For Comment (RFC) 768, adopted in August, 1980 (“UDP Specification”) or Transmission Control Protocol (“TCP”) socket as defined by the Internet Engineering Task Force (IETF) standard 7, Request For Comment (RFC) 793, adopted in September, 1981 (“TCP Specification”). To receive the network packet, the connection for example, may have an open TCP socket interface and be waiting for incoming data. In some embodiments the connection can be part of the knowledge engine.

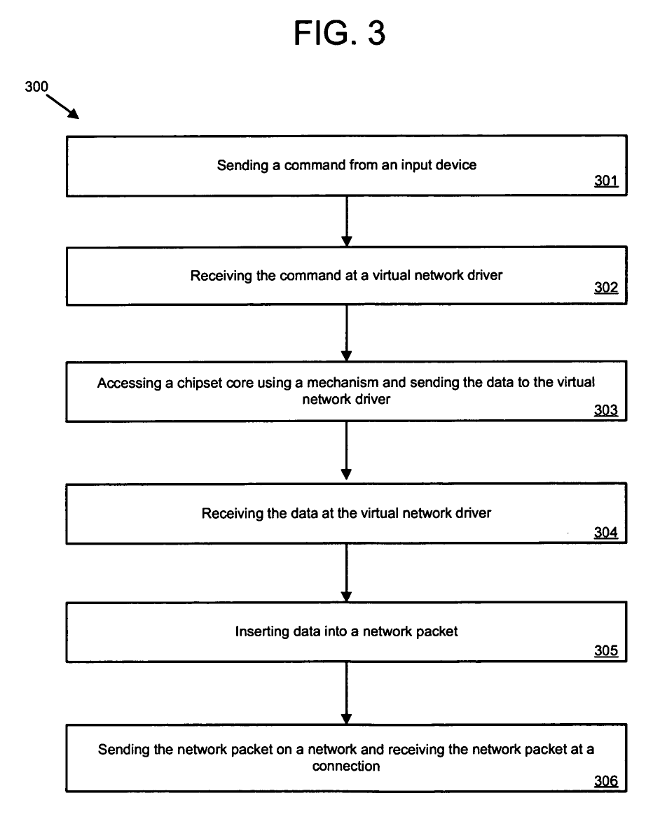

Referring now to FIG. 3, an embodiment of a method 300 is shown. At 301 an input device sends a command. In some embodiments, the input device may be a knowledge engine as described previously. At 302 a virtual network driver receives the command from the input device. The virtual network driver may be a chipset specific driver in which register locations of one or more chipsets are known. At 303 the virtual network driver accesses a multicored chipset or several chipsets serving as individual cores based on the command sent from the input device. Accessing an individual core in a multicored environment requires the use of a mechanism. An example of a mechanism is an Inter Partition Bridge (“IPB”) mechanism. However, any mechanism that allows access to individual cores in a multicored environment may be used. The chipset core accessed at 303 in some embodiments may contain any of one or more MSRs, one or more debug registers, and one or more debug sensors. Such registers may contain data used by a knowledge engine.

At 304, the chipset core sends data to the virtual network driver and the virtual network driver receives the data. The data sent may be the data requested by the command initially sent to the virtual network driver at 302.

At 305, a network subsystem creates a network packet that contains the requested data. In some embodiments, the network packet is an IEEE 802.3 or an Ethernet packet and the network subsystem creates a network packet by adding IEEE 802.3 or Ethernet header information, Internet protocol header information and inserting the error data into the packet. In some embodiments, the virtual network driver creates the network packet.

At 306 the network packet is sent via a network and is received at a connection. In some embodiments, the connection can be a UDP socket or a TCP socket. To receive the network packet, the connection for example, may have an open TCP socket interface and be waiting for incoming data. In some embodiments the connection can be part of the knowledge engine.

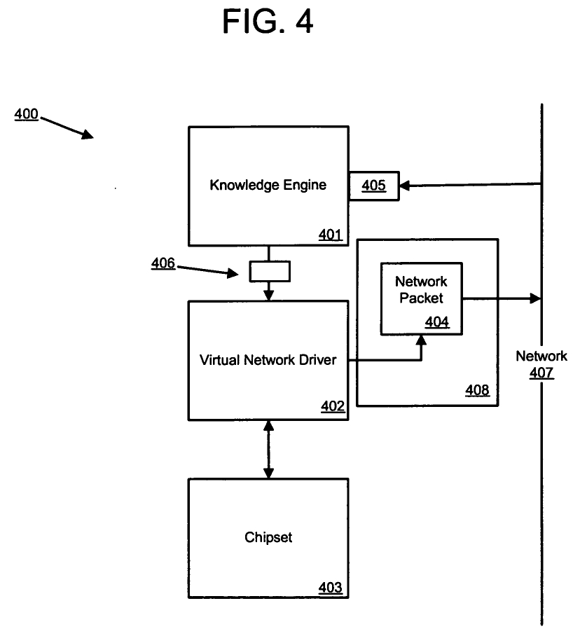

Referring now to FIG. 4, an embodiment of a system is shown. A knowledge engine 401 sends a command 406 to a virtual network driver 402 with instructions to accesses a chipset core 403. The virtual network driver 402 may be a chipset specific driver in which register locations of one or more chipsets are known. The virtual network driver 402 receives the command 406 and accesses the chipset core 403 based on the command 406. In some embodiments, the command 406 can be an input output control (“IOCTL”) command, or a switch command. The chipset core 403 sends data to the virtual network driver 402 based on the command 406. A network subsystem 408 generates a network packet 404 and error data from the virtual network driver 402 is inserted into the network packet 404. In some embodiments, the virtual network driver 402 creates the network packet 404. The network packet 404 may be sent via a network 407 and is received at connection 405. In some embodiments connection 405 can be a UDP socket or a TCP socket. In some embodiments the connection 405 is part of the knowledge engine 401.

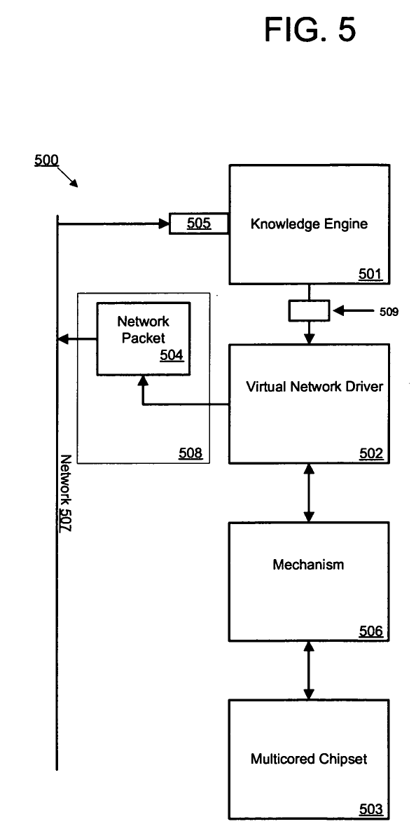

Referring now to FIG. 5, an embodiment of a system is shown. A knowledge engine 501 sends a command 509 to a virtual network driver 502 with instructions to accesses a chipset core 503. The virtual network driver 502 may be a chipset specific driver in which register locations of one or more chipsets are known. The virtual network driver 502 receives the command 509 and accesses the chipset core 503 based on the command 509. In some embodiments, a mechanism 506 to is used to connect a main partition on the multicored environment to a sequestered partition. Each partition may also be referred to as a core. An example of a mechanism 506 is an Inter Partition Bridge (“IPB”) mechanism. In some embodiments, the command 509 can be an IOCTL command, or a switch command. The chipset core 503 sends data to the virtual network driver 502 based on the command 509 received. A network subsystem 508 generates a network packet 504 and error data from the virtual network driver 502 may be inserted into the network packet 504. In some embodiments, the virtual network driver 502 creates the network packet 504. The network packet 504 may be sent via a network 507 and may be received at connection 505. In some embodiments connection 505 is a UDP socket or a TCP socket. In some embodiments the connection 505 is part of the knowledge engine 501.

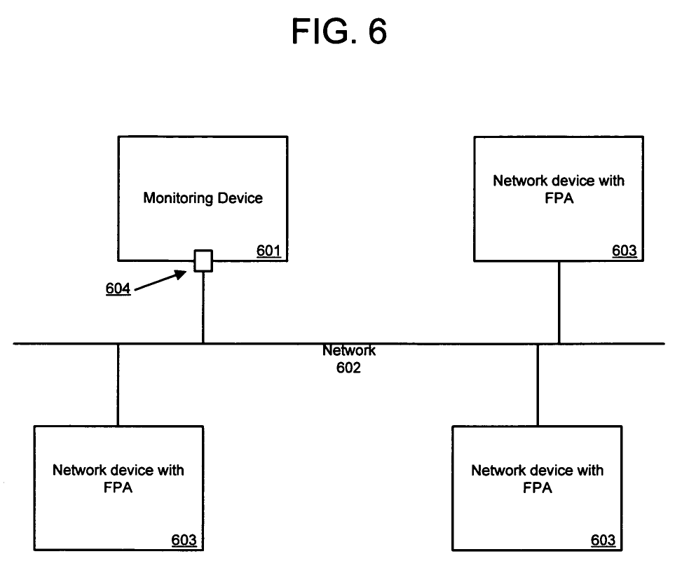

Referring now to FIG. 6, an embodiment of a system is shown. A network 602 may be connected to many network devices 603. In some embodiments network devices 603 may consist of but are not limited to a personal computer (“PC”) or a server. Network devices 603 may contain a virtual network driver, a first multicored chipset and a second multicored chipset. A monitoring device 601 may have a connection 604 that receives information from a plurality of network devices 603 each containing a fault prediction agent. Monitoring device 601 may contain a knowledge engine.

In some embodiments, one monitoring device 601 may send commands through a connection 604 that are received by a plurality of network devices 603 each containing a fault prediction agent.

The foregoing disclosure has been described with reference to specific exemplary embodiments thereof. It will, however, be evident that various modifications and changes may be made thereto without departing from the broader spirit and scope set forth in the appended claims.

What is claimed is:

1. A method comprising:
receiving a command at a virtual network driver from an input device; and
accessing a core of a chipset based on the command.

2. The method of claim 1, wherein the chipset has more than one core, and further comprising:
accessing a second core of the chipset based on the command.

3. The method of claim 2, wherein accessing a second core comprises:
using a mechanism to connect from a main partition to a sequestered partition.

4. The method of claim 3, wherein the mechanism is an Inter Partition Bridge mechanism.

5. The method of claim 1, further comprising:
accessing a second core of a second chipset based on the command.

6. The method of claim 5, wherein accessing a second core comprises:
using a mechanism to connect from a main partition to a sequestered partition.

7. The method of claim 1, wherein the input device is a knowledge engine and the chipset is a processor.

8. The method of claim 1, further comprising:
sending data from the chipset to the virtual network driver;
receiving the data sent by the chipset at the virtual network driver, the virtual network driver inserting the data into a network packet;
sending the network packet over a network; and
receiving the network packet at a connection.

9. The method of claim 8, wherein the connection is a UDP or TCP socket connection and the command is an IOCTL command.

10. The method of claim 8, wherein the connection is part of a knowledge engine.

11. The method of claim 1, wherein the virtual network driver contains register memory locations of the chipset.

12. A system comprising:
an input device;
a virtual network driver; and
a first core of a first chipset having more than one core;
a second core of a second chipset;
wherein the first chipset is to send data to the virtual network driver, the virtual network driver is to receive data sent by the first chipset, and the input device is to send a command to the virtual network driver and is to receive data via a network packet.

13. The system of claim 12, wherein the input device is a knowledge engine and the first chipset is a processor.

14. The system of claim 12, wherein the virtual network driver is to insert data into a network packet.

15. A medium storing instructions adapted to be executed by a processor to perform a method of accessing a core of a chipset, the instructions comprising:
instructions for receiving a command at a virtual network driver from an input device; and
instructions for accessing a core of a chipset based on the command.

16. The medium of claim 15, further comprising:
instructions for accessing a second core of the chipset based on the command, wherein the chipset has more than one core.

17. The medium of claim 15, further comprising:
instructions for accessing a second core of a second chipset based on the command.

18. The medium of claim 15, wherein the input device is a knowledge engine and the chipset is a processor.

19. A system comprising:
a virtual network driver;
a first core of a first chipset, wherein the chipset has more than one core;
a second core of a second chipset;
a knowledge engine; and
an Ethernet network.

20. The system of claim 19, wherein the first chipset is to send data to the virtual network driver, the virtual network driver is to receive data sent by the first chipset, and the knowledge engine is to send a command to the virtual network driver and is to receive data via a network packet.
